(19) United States
(12) Patent Application Publication
(10) Pub. No.: US 2015/0283026 A1
(43) Pub. Date: Oct. 8, 2015

(54) APPARATUS FOR GENERATION OF A PRESSURE PULSE IN TISSUE

(71) Applicant: SYNERON MEDICAL LTD, Yokneam Illit (IL)

(72) Inventor: Avner Rosenberg, Bet Shearim (IL)

(73) Assignee: SYNERON MEDICAL LTD, Yoqneam Illit (IL)

(21) Appl. No.: 14/647,087

(22) PCT Filed: Dec. 19, 2013
(86) PCT No.: PCT/IL2013/000095

§ 371 Date: May 23, 2015

Related U.S. Application Data
(60) Provisional application No. 61/751,892, filed on Jan. 13, 2013.

(51) Int. Cl. A61H 23/00; A61H 9/00; A61H 23/02

(52) U.S. Cl. CPC A61H 23/006; A61H 23/0254; A61H 9/0057; A61H 2201/1664; A61H 2201/5097

(57) ABSTRACT

An apparatus for generation of a pressure pulse for treatment of soft tissue including one or more chambers having an open end operative to be sealed by skin when applied thereto rendering the chamber air tight, a vacuum pump communicating with the chamber and operative to generate at least partial vacuum inside the chamber and a plunger operative to move axially relative to the chamber towards and away from the skin and engage the skin without breaking the air tightness of the chamber and wherein the plunger is operative to engage skin against vacuum forces during a first phase and disengage the skin during a second phase.

### TECHNICAL FIELD

The apparatus relates to cosmetic and medical devices and more specifically to such devices for non-invasive treatment of soft tissue such as adipose tissue.

### BACKGROUND

Adipose tissue is located under the skin layer. Various devices have been used for the treatment of adipose tissue, partial reduction of which leads to what is known as “circumference reduction.” Thus, energy applied to the skin surface to degrade adipose tissue must pass through the skin layer to reach the adipose tissue without damaging the skin.

As described in U.S. Pat. No. 7,857,775 to the same assignee of the current application, a pressure pulse is commonly applied to a region of skin overlying a volume of soft tissue. The pressure pulse inside the tissue has at least one negative pressure phase generated, for example, by vacuum inside an applicator or chamber applied to tissue to be treated and pulls the tissue outwards from the body.

The negative pressure phase is either followed or preceded by a positive pressure phase in order to return tissue pulled outwards from the body back to its original state. This may be repeated several times in a form of a train of pulses, each pulse having a negative pressure phase and a positive pressure phase applied to the surface of skin.

In the case of adipose tissue, the action of the negative pressure phases causes destruction of fat cells with little or no damage to other tissues since fat cells are larger and weaker than most other cells. The intensity and time profiles of the pressure pulse are also selected to cause maximal destruction of the adipocytes (fat cells) with minimal or no damage to other tissues. In the case of other types of soft tissues, such as muscle tissue or connective tissue, the pulses create a massaging effect of the tissue.

In Patent Cooperation Treaty Application No. PCT/IL2011/000862 to the same inventor and same assignee of the current application, the positive pressure phase duration is substantially longer than the negative pressure phase duration.

The use of apparatuses having vacuum chambers to pull a segment of skin into a chamber and apply thereto various energy treatments is known. However, such apparatuses commonly contain a rigid plate or a flexible membrane, or a combination of a rigid plate and a flexible membrane located in the interior of the chamber. Commonly the plate or plunger is in sealing contact with the chamber walls as it moves within the vacuum chamber. The sealing contact creates significant friction between the plate and the chamber walls. The plate or membrane is forced to rapidly move in the chamber away from the surface of the skin, the movement generating a negative pressure in the portion of the chamber interior between the surface of plate or membrane and the skin. Such solutions having skin-engaging elements such as rigid plates, flexible membranes or combinations thereof can also be limited by the very fine balance required between flexibility and rigidity of the skin engaging element.

Vacuum based soft tissue and primarily adipose tissue treatment devices based on rigid plungers and primarily the speed at which the negative phase is created by the plungers can be limited by friction between the plunger and cylinder. Another limitation can be deterioration over time in the durability of an air tightness seal between the plate or plunger and the vacuum chamber.

### SUMMARY

The current apparatus seeks to provide an apparatus for generation of a pressure pulse for treatment of soft tissue.

There is thus provided in accordance with an example an apparatus including a housing enclosing a vacuum chamber and a plunger. The vacuum chamber can include a skin-engaging open end and a sealed end opposite the open end and a plunger operative to move axially inside and at least partially outside of the vacuum chamber towards or away from the skin without compromising the air tightness of the chamber and having a head spanning most of the open end without engaging rims of the open end or walls of the vacuum chamber.

In accordance with an example, the housing can also include an actuator operative to drive the plunger axially towards and away from the skin and a retention hook that can lock the plunger in place in an extended state against a bias.

In accordance with another example the open end of the vacuum chamber can be sealed by a flexible membrane rendering the chamber airtight. The membrane can be reusable or be disposable and be replaced following each treatment.

In accordance with yet another example the membrane can include a centrally located cutout so that to form a ring.

In accordance with still another example a controller can activate the apparatus to apply a pressure pulse formed by a slow phase during which the plunger slowly travels towards and engages the skin and a fast phase during which the plunger travels away from and disengages the skin.

In accordance with another example the apparatus can be operative to apply a treatment pulse to skin and to extend a plunger through the chamber towards the skin without breaking the air tightness of the chamber and slowly urge the skin into the body of a user, lock the plunger in the extended position against a loaded bias, partially evacuate the vacuum chamber and create partial vacuum within the chamber bringing about urging of the skin against the plunger and allow the loaded bias to expand, rapidly drive the plunger away from the skin and allow the skin to be pulled into vacuum chamber.

In accordance with yet another example the vacuum pump can be operative to maintain a continuous and constant level of vacuum within the vacuum chamber throughout the pressure pulse.

### BRIEF DESCRIPTION OF THE DRAWINGS

The present method and apparatus will be understood and appreciated more fully from the following detailed description, taken in conjunction with the drawings in which:

FIG. 1A is a partial block, sectional view simplified illustration of an apparatus for generation of a pressure pulse for treatment of soft tissue in accordance with an example;

FIG. 1B is a sectional view simplified illustration of a locking mechanism for an apparatus for generation of a pressure pulse in accordance with another example;

FIGS. 2A and 2B are partial block, sectional view simplified illustrations of an apparatus for generation of a pressure pulse for treatment of soft tissue in accordance with yet another example;

FIGS. 3A, 3B and 3C are partial block, sectional view simplified illustrations of operation of an apparatus for generation of a pressure pulse for treatment of soft tissue in accordance with still an example;

FIG. 4 is a cross-section view simplified illustration of a plunger head of an apparatus for generation of a treatment pulse in accordance with another example; and

FIG. 5 is a block diagram depicting a method of application of a treatment pulse using an apparatus for generation of a pressure pulse for treatment of soft tissue in accordance with yet another example.

### DETAILED DESCRIPTION

The terms “skin”, “tissue” and “soft tissue” are used interchangeably in the present disclosure and mean any superficial body tissue layer, primarily one or more of the following body tissue layers: skin, fat, collagen and muscle.

The term “vacuum” as used in this disclosure refers to negative pressure with respect to ambient air pressure generated within an applicator by evacuation of air from a chamber. For example, a vacuum pump could be used to evacuate air from the chamber. Negative pressure or vacuum could pull skin into the chamber.

The term “operating cycle” as used in the present disclosure refers to action of the disclosed apparatus effecting a treatment pressure pulse on tissue. A full operating cycle includes a slow phase during which a plunger moves towards skin/tissue and a fast phase during which a plunger moves away from skin/tissue.

The term “treatment pressure pulse” as used in this disclosure means an effect of an operating cycle on tissue and includes a negative pressure pulse phase and a positive pressure pulse phase.

The term “negative pressure pulse phase” as used in this disclosure refers to negative pressure generated inside tissue by the action of the disclosed apparatus during the fast phase of the operating cycle.

The term “positive pressure pulse phase” as used in this disclosure refers to positive pressure generated inside tissue during the slow phase of the operating cycle by, for example, compression of tissue into the body (e.g., before a fast phase of an operating cycle).

Apparatuses as used in the art having vacuum chambers commonly contain a piston attached to a rigid plate, a flexible membrane or a combination of a rigid plate and a flexible membrane located in the interior of the chamber and operative to sealingly and axially slide along walls within the vacuum chamber.

In apparatuses described above, the speed of movement of the piston towards and away from the surface to which the chamber is applied (e.g., skin) is commonly the same in either direction. Fast pulling of the skin into the chamber does not allow the skin sufficient time to stretch before being sucked into the vacuum chamber resulting in a pulling or shearing sensation in the skin, primarily in portions underlying the rims of the vacuum chamber, commonly resulting in pain. Additionally, skin being pulled into the vacuum chamber slides across the rims of the vacuum chamber while, concurrently being urged against the chamber rim. The friction between the skin and the chamber rims adds to the discomfort of a user. Additionally, the seal formed between the piston and the chamber walls creates a friction force which makes it very difficult to provide fast movement of the piston.

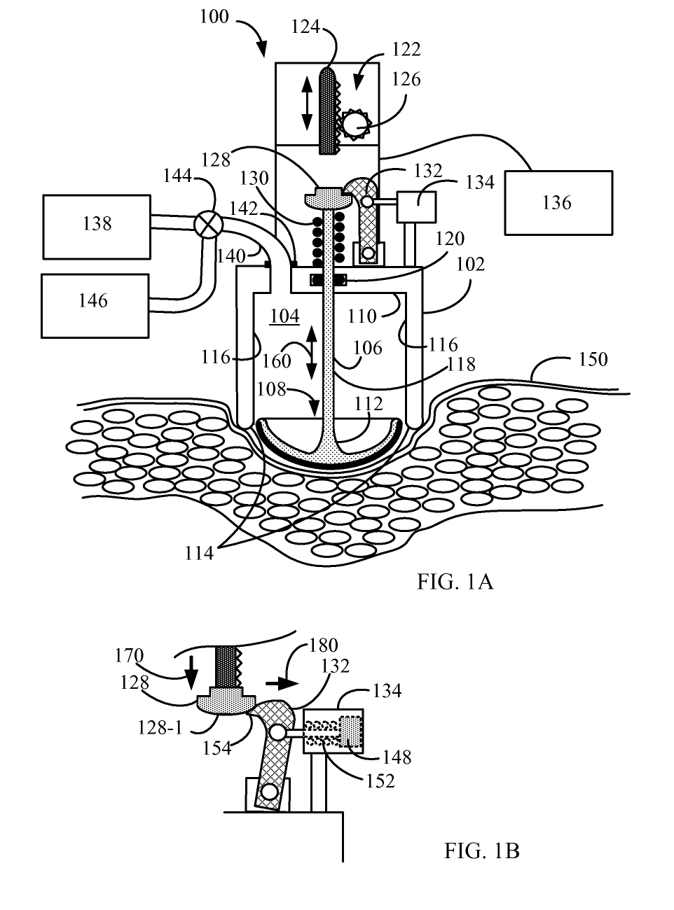

Referring now to FIGS. 1A and 1B, which are partial block, sectional view simplified illustrations of an apparatus for generation of a pressure pulse for treatment of soft tissue in accordance with an example. As will be explained in greater detail below, an apparatus for generation of a treatment pressure pulse 100 for treatment of soft tissue in general and specifically adipose tissue includes a mechanism that provides fast driving of skin to which apparatus 100 is applied away from the body and into a chamber with minimal or no pain to a subject. The mechanism includes reduced plunger-cylinder friction and an operating cycle phase-dependent plunger speed as will be described in further detail below. The fast pulling of skin away from the body produces a fast negative pressure pulse in subcutaneous fat and collagen. This negative pressure pulse can induce therapeutic effects on the fat and collagen.

Apparatus for generation of a treatment pressure pulse 100 can include a housing 102 enclosing a vacuum chamber 104 and a plunger 106. Housing 102 can be cylindrical but not necessarily have a circular cross-section. Vacuum chamber 104 can include a skin 150-engaging open end 108 and a sealed end 110 opposite open end 108. Open end 108 can be sealed by a resilient surface such as, for example, skin 150 to which apparatus 100 can be applied, urged against open end 108 rims 114 rendering chamber 104 airtight.

Plunger 106 can be operative to move axially inside and at least partially out of housing 102 vacuum chamber 104 towards or away from skin 150 in directions indicated by an arrow designated reference numeral 160 without compromising the air tightness of chamber 104 formed and maintained by skin 150 urged against vacuum chamber 104 rims 114. Plunger 106 can include a head 112 that spans most of open end 108 without engaging open end 108 rims 114 or chamber 104 walls 116 and a shaft 118, which can extend through and out of chamber 104 through an air tightness seal such as a first O-ring 120 in sealed end 110. Head 112 could be convex in shape and operative to urge and temporarily deform skin 150 into the body in a way comfortable for a subject.

Housing 102 can also include an actuator 122 driven by a motor (not shown) that can, for purposes of example only, be a linear actuator such as a rack 124 and pinion 126 type or any other actuator known in the art operative to drive plunger 106 axially towards and away from skin 150.

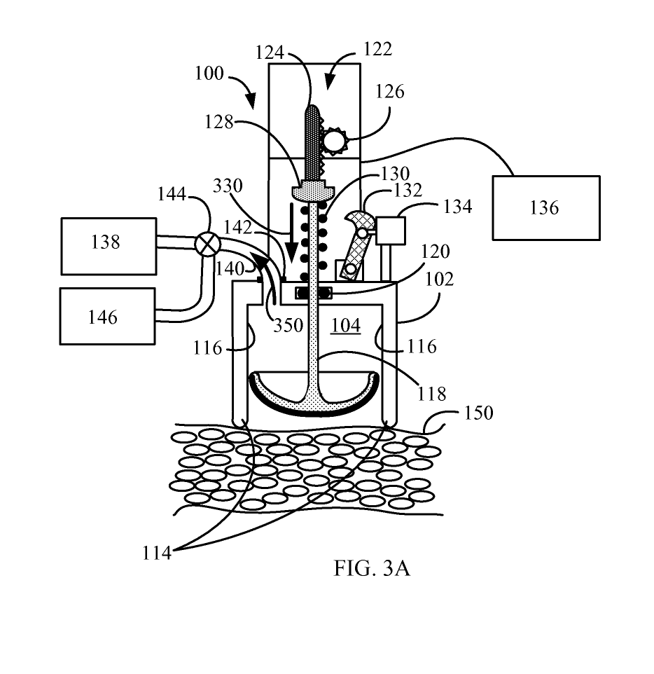

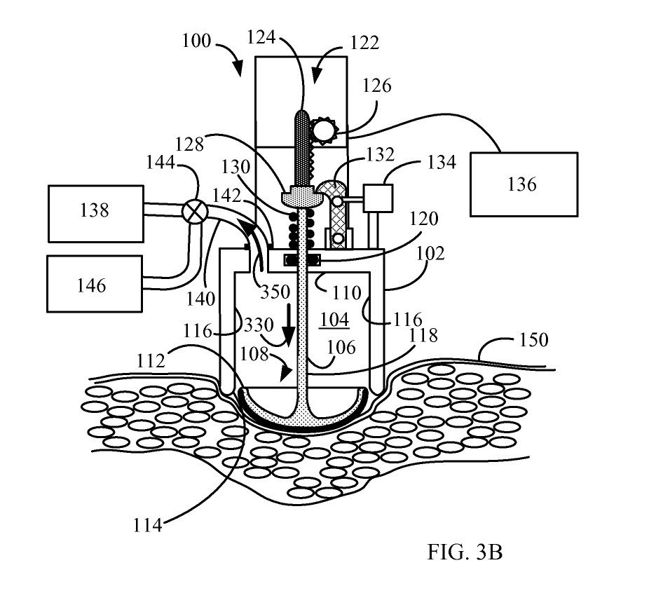

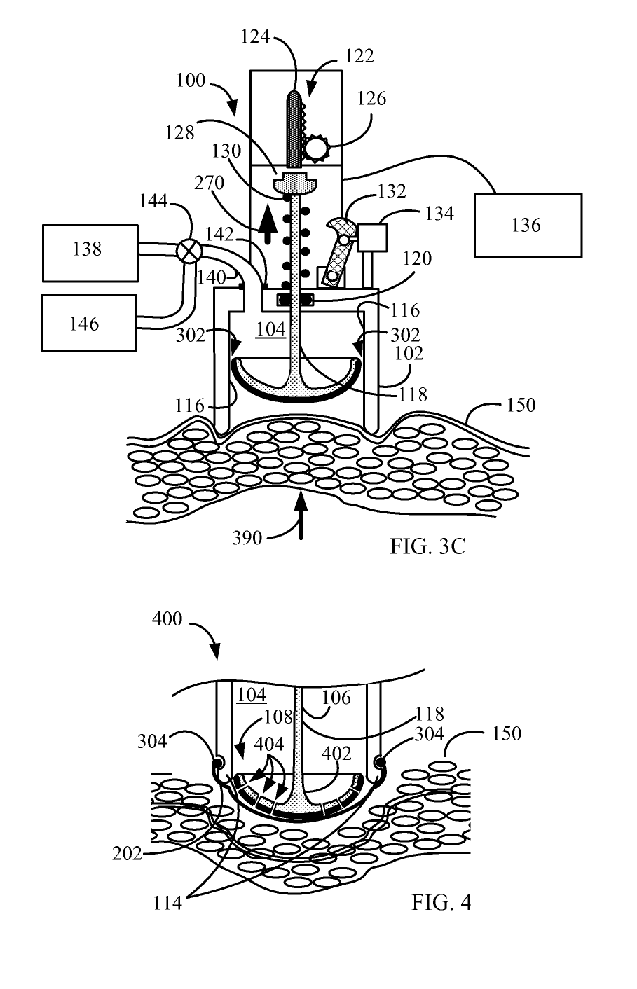

Rack 124 can be detached from and operative, when activated, to engage base 128. When activated, rack 124 can move towards skin 150 urging base 128 against a bias 130 as shown in FIGS. 3A and 3B. As shown in FIG. 1A and FIG. 1B, a retention hook 132 having a lip 154 and driven by a driver 134 including for example, a solenoid 148, can be operative to lock base 128 in place against loaded bias 130. In FIG. 1A, base 128 is locked in place by retention hook 132 against loaded bias 130.

Once base 128 is locked in place, pinion 106 can drive rack 124 in a direction away from skin 150 back to its original retracted position, distancing rack 124 from base 128. Optionally and alternatively, pinion 106 can disengage rack 124 so that to allow free axial movement of rack 124.

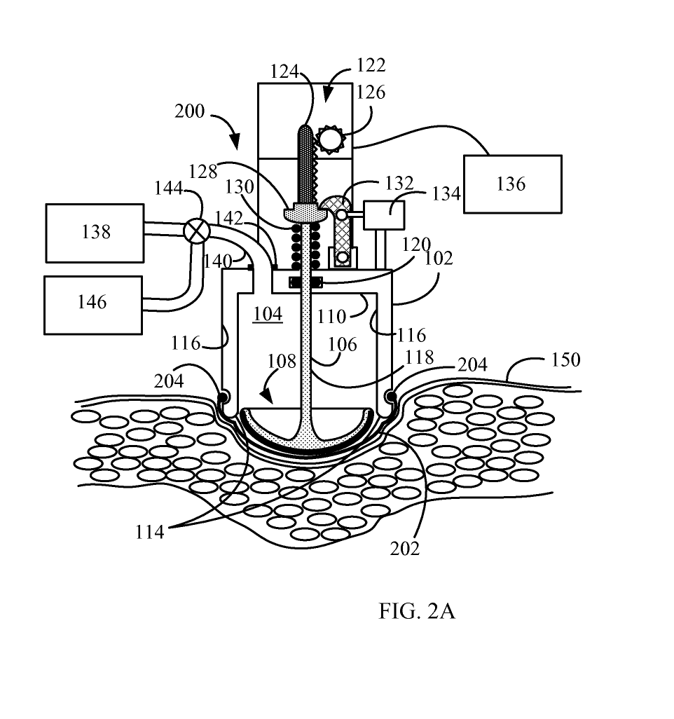

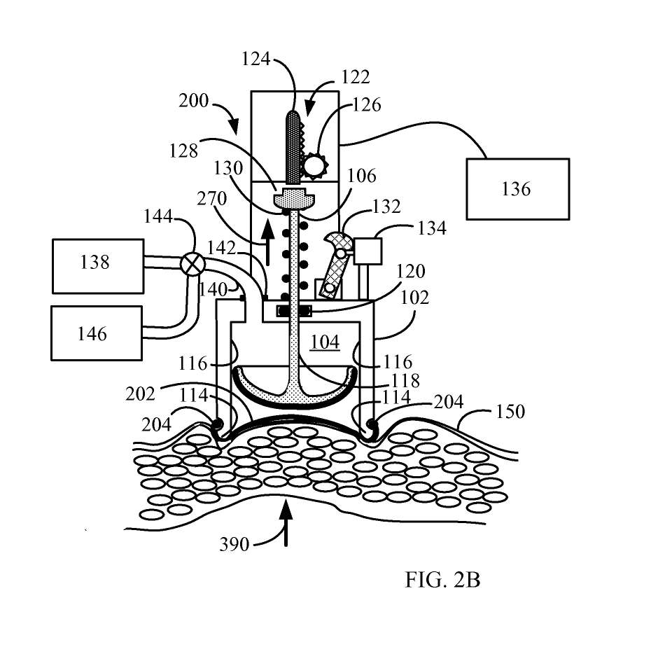

Once retention hook 132 releases base 128, plunger 106 can be driven back to its retracted position (similar to that depicted in FIG. 2B) by a force exerted by bias 130 alone as will be explained in greater detail below. In other examples, plunger 106 can be restored to its original position by other driving mechanisms such as, for example, a solenoid, positive air pressure and similar.

A controller 136 can communicate by wired and/or wireless communication with, and control activation of, actuator 122 and driver 134 as well as other components of apparatus 100 as will be explained in greater detail below.

A vacuum pump 138 can communicate with chamber 104 directly or via one or more conduits 140 through an air tightness seal such as a second O-ring 142 in sealed end 110 to generate vacuum inside chamber 104.

A flow of air into or out of chamber 104 can be regulated by one or more valves 144 located between pump 138 and chamber 104. Additionally and optionally, one or more valves 144 can communicate with ambient air and/or a positive pressure pump 146 and be operable to deliver air into chamber 104 either from ambient air or from positive pressure pump 146.

In some examples such as, for example, during repeated operation, vacuum pump 138 can apply to chamber 104 a continuous and constant level of vacuum. The level of vacuum inside chamber 104 can thus be regulated by one or more valves 144 by, for example, allowing a predetermined volume of ambient air to continuously or intermittently enter chamber 104 for a predetermine period of time thus reducing the level of vacuum inside the chamber for the duration of the predetermined period of time. This reduces load on the vacuum pump 138 and enables using low speed pumps.

Optionally and alternatively, valve 144 can allow a period of vacuum pumping followed by a period of ambient air or positive pressure air delivered into the chamber, the pumping and pressurizing can be done repeatedly, reducing and elevating the air pressure inside the chamber 104 at predetermined intervals.

It will be appreciated by those skilled in the art that any level and/or frequency of vacuum and positive pressure applied by chamber 104 can be regulated by one or more valves 144 communicating with one or more vacuum pump 138, positive pressure pump 146 and ambient air and controlled by controller 136.

As depicted in FIG. 1B, which is a sectional view simplified illustration of a locking mechanism for an apparatus for generation of a treatment pressure pulse in tissue, base 128 could have an angled or curved surface 128-1 operative, when moving towards skin 150 as indicated by an arrow designated reference numeral 170 to slide against and urge retention hook 132 out of base 128 path of travel in a direction indicated by an arrow designated reference numeral 180 against a bias 152 inside driver 134 indicated in FIG. 1B by phantom lines. Once base 128 has traveled beyond lip 154 of retention hook 132, bias 152 could re-expand returning retention hook 132 to its original position and locking base 128 in place against loaded bias 130 (FIG. 1A).

A solenoid 148 or any similarly operating mechanism, attached to retention hook 132 can pull retention hook 132 in a direction indicated by arrow 180 to unlock base 128 and allow plunger 106, driven by expanding bias 130 to move rapidly away from skin 150 in a direction indicated by arrow designated reference numeral 270 (2B and 3C) opposite to the direction indicated by arrow 170 as will be explained in greater detail below.

FIGS. 2A and 2B, depict partial block, sectional view simplified illustrations of an apparatus 200 for generation of a treatment pressure pulse for treatment of soft tissue in accordance with another example. Open end 108 can be sealed by a flexible membrane 202 rendering chamber 104 airtight. The seal provided by membrane 202 can be maintained regardless of the quality of contact between housing 102 open end 108 and skin 150. In accordance with the example shown in FIG. 2A, when applied to skin 150, membrane 202 can come in contact with a surface such as skin 150 and become disposed between plunger 106 head 112 and the surface such as, for example, skin 150.

Membrane 202 can be attached to attachment points 204 on the outer surface of housing 102 walls 116 so that when applied to skin 150, rims 114 come into indirect contact with and are urged against the surface of skin 150 through membrane 202, which are disposed between rims 114 and skin 150. Membrane 202 can be reusable or be disposable and be replaced following each treatment. A disposable membrane 202 can contribute to increased hygienic use of apparatus for generation of a pressure pulse 200 as well as to reduced cost of operation of apparatus 200.

Additionally, membrane 202 can prevent debris and coupling gel or oil, if used, from entering chamber 104, vacuum generating pump 138 and conduits 140.

Additionally and optionally, the flexibility of a flexible membrane 202 can be limited by manufacturing membrane 202 from a material selected for having a predetermined limited flexibility. A membrane 202 having a predetermined limited flexibility can limit movement of the skin preventing user pain resulting from over pulling on skin 150 as will be explained in further detail below.

Additionally and optionally, attachment points 204 can include a safety feature of apparatus for generation of a pressure pulse 200 in which attachment points 204 detach at a pre-determined level of tension on membrane 202 so that to prevent over pulling of skin 150.

In the examples illustrated in FIGS. 1 and 2, water, gel, cream, oil or any other material that can fill gaps between plunger head 112 and skin 150 or between membrane 202 and skin 150 and urge air out from apparatuses 100/200-skin 150 interface when coupling apparatuses 100/200 to skin 150.

Reference is now made to FIGS. 3A, 3B and 3C, which are partial block, sectional view simplified illustrations of operation of an apparatus 100 for generation of a treatment pressure pulse for treatment of soft tissue in accordance with still another example. Apparatus 100 can be applied to skin 150 so that skin 150 seals open end 108 rendering chamber 104 airtight.

Controller 136 can be operative to apply an operating cycle having a slow phase and a fast phase. Plunger 106 can be operative to move axially towards skin 150 and extend at least partially beyond rims 114, engage skin 150 and urge soft tissue lying below plunger 106 head 112 into the body.

Speed of movement of plunger 106 can depend on the phase of the operating cycle, so that when controller 136 activates apparatus 100 to generate one or more operating cycles, plunger 106 moves slowly towards skin 150 so that to generate a slow phase of the operating cycle followed by a fast movement away from skin 150 to generate a fast phase of the operating cycle. The slow phase of the operating cycle generates a positive pressure pulse phase of a treatment pulse in the tissue whereas the fast phase of the operating cycle generates a negative pressure pulse phase of a treatment pulse in the tissue. Controller 136 is operative to set slow plunger 106 movement towards and against skin 150, followed by fast movement of plunger 106 away from the skin 150, thus generating inside the tissue a slow (long) positive pressure pulse phase and a fast (short) negative pressure pulse phase of a treatment pulse.

It will be appreciated to those skilled in the art that the slow phase of the operating cycle can be followed by the fast phase of the operating cycle and vice versa.

The pressure change in the tissue during the course of the slow phase of the operating cycle is substantially slower than the pressure change in the tissue during the course of the fast phase of the operating cycle. During the slow phase of the operating cycle, plunger 106 slowly displaces or pushes all of the skin layers, including the adipose tissue into the treated body. The slow displacement of the skin and underlying tissue by plunger 106 slowly deforms and stretches the skin so that during the fast phase of the operating cycle skin 150 is not stretched but only bent as the vacuum inside chamber 104 pulls and displaces skin 150 to be treated outwards from the body.

Additionally, skin being pulled into the vacuum chamber, being already stretched during the slow phase of the operating cycle, only bends around rims 114 of vacuum chamber 104 minimizing discomfort for a user resulting from skin sliding across rims 114. This also reduces pain associated with fast and sudden stretching of the skin as well as other adverse effects on skin.

Controller 136 can be operative to apply a typical operating cycle that includes a slow phase commonly slower (longer) than 10 mSec and a fast phase commonly faster (shorter) than 10 msec. Controller 136 can activate apparatus 100 to form a train of operating cycles effecting a train of treatment pressure pulses, each cycle having a fast phase and a slow phase applied to the surface of skin.

In examples such as those depicted in FIG. 2, flexible membrane 202 can cushion the bending of skin 150 further preventing stretching of skin 150 by suction action effected on skin 150 by vacuum inside chamber 104. In configurations in which membrane 202 can be stretchable, the degree to which membrane 202 could be stretched can be limited to prevent overstretching of skin 150 when pulled into vacuum chamber 104.

FIG. 3A illustrates application of apparatus 100 to skin 150 so that skin 150 seals chamber 104 rendering it airtight and initiation of a slow phase of a operating cycle. Controller 136 can be operative to apply a operating cycle effecting a tissue treatment pulse to a region of skin overlying a volume of soft tissue and initiate the slow phase of the operating cycle by activating actuator 122 to slowly drive rack 124 towards skin 150 axially slowly moving plunger 106 in a direction indicated by an arrow designated reference numeral 330 so that head 112 begins slow movement towards skin 150 against and loading bias 130.

FIG. 3B depicts the end of the slow phase of the operating cycle at which head 112 extends beyond rims 114 of chamber 104, engaging skin 150, urging and deforming tissue below head 112 into the body applying a positive pressure pulse phase of the treatment pressure pulse inside the tissue. The slow speed of the slow operating cycle phase, together with the convex shape of plunger 106 head 112, minimize discomfort of the patient during treatment. At the end of the slow phase, base 128 of plunger 106 can be locked in place by retention hook 132 against loaded bias 130 as described above.

In the example depicted in FIGS. 2A and 2B, FIG. 2A illustrates apparatus 200 at the end of the slow phase of the operating cycle, whereas FIG. 2B depicts apparatus 200 at the end of the fast phase of operating cycle.

Before or during the slow phase of operating cycle or immediately at the end thereof, vacuum pump 138 can be operative to at least partially evacuate air from vacuum chamber 104 as indicated by an arrow designated reference numeral 350 to “preload” vacuum chamber 104 by creating vacuum or partial vacuum in chamber 104 relative to ambient air pressure.

As described above, controller 136 can set vacuum pump 138 to apply to chamber 104 a desired level of vacuum. Alternatively and optionally, controller 136 can set vacuum pump 138 to apply to chamber 104 a continuous and constant level of vacuum while setting the level of vacuum inside chamber 104 by regulating one or more valves 144 introducing measured volumes of ambient air into chamber 104. Alternatively and optionally, controller 136 can set valve 114 to allow ambient air or pressurized air from pump 146 to enter chamber 104. Controller 136 can also be operative to generate partial vacuum in chamber 104 before the fast phase of the operating cycle begins as well as to let ambient air or pressurized air into chamber 104 after the fast phase of the operating cycle ended. Controller 136 can also be operative to alternate vacuum, ambient air and/or positive air pressure inside chamber 104. Alternatively and optionally, controller 136 can be operative to keep constant partial vacuum in chamber 104 during repeated operating cycles.

The pressure differential between tissue or skin 150 and vacuum chamber 104 attempts to pull skin 150 into chamber 104. Extended and locked plunger 106 head 112 engages and holds skin 150 in check against vacuum forces inside chamber 104 and acts as a barrier stopping skin 150 and underlying tissue from being pulled into vacuum chamber 104.

At this point in time and as shown in FIG. 3C, controller 136 can initiate a fast phase of the operating cycle by releasing the lock effected by retention hook 132. Loaded bias 130, free to expand, can exert force on base 128 driving plunger 106 head 112 away from skin 150 in a direction indicated by an arrow designated reference numeral 270 and disengaging skin 150. Fast movement of plunger 106 during the fast phase of the treatment pulse can occur in a partial vacuum inside vacuum chamber 104, reducing the density of air inside vacuum chamber 104 thus reducing air friction created by air escaping through a narrow gap 302 between plunger 106 head 112 and vacuum chamber 104 walls 116.

Fast movement of plunger 106 is also enabled by rack 124 being already in a fully retracted state as explained above.

During the fast phase of the operating cycle, plunger 106 can disengage and move away from skin 150 at a speed greater than the speed at which skin 150 is pulled into vacuum chamber 104 so that once movement of plunger 106 begins it can lose contact with skin 150 and not contact skin 150 for the remainder of the fast phase of the operating cycle.

At this stage, in which head 112 disengages skin 150 and no longer presses against skin 150, skin 150 can be free to be rapidly pulled into chamber 104 as indicated by an arrow designated reference numeral 390 (FIGS. 2B and 3C), driven by the pressure differential between the tissue or skin 150 and the vacuum within chamber 104, tissue pressure typically being close to ambient air pressure, or a little higher due to blood pressure. FIGS. 2B and 3C illustrate apparatus 200 approaching the end of the fast phase of the operating cycle.

During the operating cycle, the plunger pushes the skin at a speed slower than the speed at which it disengages the skin. The plunger travel time during the slow phase of the operating cycle can be more than 10 msec and during the fast phase of the operating cycle can be less than 10 msec.

It will be appreciated by those skilled in the art that in the configurations described above, during the fast phase of the treatment pulse, the force at which skin 150 is drawn against plunger 106 when in the extended position or pulled into vacuum chamber 104 once plunger 106 is retracted and disengages skin 150, depends solely on the pressure differential between tissue pressure and vacuum or partial vacuum inside chamber 104 and is not affected by the distance between plunger 106 head 112 and skin 150 during retraction of plunger 106 or by the rate of acceleration at which plunger 106 is retracted away from skin 150. In other words, retraction of plunger 106 into chamber 104 and movement thereof away from skin 150 does not generate a vacuum between plunger 106 head 112 and skin 150 and/or affect the existent vacuum inside chamber 104.

Controller 136 can be operative to follow the above described operating cycle by a train of operating cycle in which plunger 106 can continue moving towards and away from skin 150 bending the skin and producing in the tissue consecutive treatment pressure pulses each including a negative pressure pulse and a positive pressure pulse in the soft tissue inducing therapeutic effects on fat and collagen. During the slow phase of the operating cycle, skin 150 can be deformed without discomfort as explained above. During the fast phase of the operating cycle vacuum inside vacuum chamber 104 can pull and bend already deformed skin 150 thus reducing stretching of the skin, pain and adverse effects on the skin as described in the aforementioned U.S. Pat. No. 7,857,775 and Patent Cooperation Treaty patent application PCT/IL2011/000862.

Controller 136 can activate vacuum pump 138, positive pressure pump 146 and one or more valves 144 during or between operating cycle phases to generate negative or positive pressure inside chamber 104 as necessary in course of either one of the operating cycle phases to assist in urging skin 150 into the body or pulling skin 150 away from the body. Controller 136 can also control the duration of negative or positive operating cycle phases as well as synchronize between the timing of vacuum or partial vacuum and Ambient or positive air pressure inside chamber 104 and movement of plunger 106.

Additionally, controller 136 can activate vacuum pump 138 and maintain vacuum within vacuum chamber 104 throughout the operating cycle so that movement of skin 150 into vacuum chamber 104 depends solely on engagement or disengagement of plunger 106 head 112 with skin 150.

Reference is now made to FIG. 4, which is a cross-section view simplified illustration of a plunger head of an apparatus 400 for generation of a treatment pressure pulse in tissue in accordance with an example. Head 402 of apparatus 400 could be generally similar to head 112 in the example depicted in FIG. 1A and include holes 404 to allow evacuation of trapped air between plunger 406 head 402 and skin 150 when plunger 406 is extended pressing against skin 150. In configurations such as in the example of FIG. 2, holes 404 can allow evacuation of trapped air between plunger 406 head and flexible membrane 202 (FIG. 2)

Additionally, in a fast phase of the operating cycle during which plunger 106 moves fast in a direction away from skin 150, the speed of movement of head 402 can be increased by holes 404 allowing any air that may remain in partially evacuated vacuum chamber 104 to escape through holes 404 reducing resistance on plunger 106 head 402.

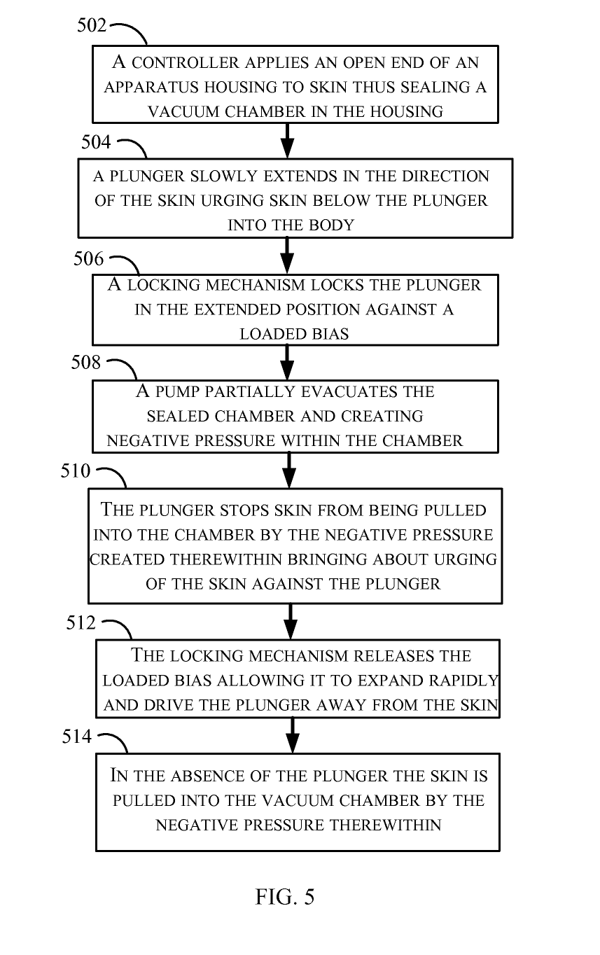

Referring now to FIG. 5, which is a block diagram depicting application of an operating cycle using an apparatus for generation of a treatment pressure pulse in tissue such as, but not limited to, apparatus 100 of FIG. 1A in accordance with an example. Apparatus 100 controller 136 can apply an operating cycle to skin 150 of a user by applying an open end 108 of an apparatus 100 housing 102 to skin 150 thus sealing vacuum chamber 104 rendering it airtight (Block 502).

Plunger 106 slowly extends in the direction of skin 150 at least partially beyond rims 114 of chamber 104, urging skin 150 below plunger 106 head 112 into the body of a user (Block 504). Retention hook 132 can lock plunger 106 in the extended position against loaded bias 130 (Block 506) and controller 136 partially evacuates sealed chamber 104 creating vacuum or partial vacuum within chamber 104 (Block 508). Plunger 106 head 112 can remain in place as a barrier against vacuum forces, holding skin 150 in check and stopping skin 150 from being pulled into vacuum chamber 104 (Block 510), driven by the pressure differential between tissue and vacuum or partial vacuum within chamber 104, bringing about urging of skin 150 against plunger 106.

Retention hook 132 can release loaded bias 130, rapidly driving plunger 106 away from skin 150 (Block 512) and allowing skin 150 to be pulled into chamber 104. Controller 136 can follow an operating cycle by a train of operating cycle as necessary for effecting treatment pressure pulses of tissue (Block 514).

For reasons of completeness, various aspects of the present apparatus are set out in the following numbered clauses:

Clause 1. Apparatus comprising:
at least one chamber having an open end operative to be sealed by skin when applied thereto rendering the chamber air tight;
a vacuum pump communicating with the chamber and operative to generate at least partial vacuum inside the chamber; and
a plunger operative to move axially relative to the chamber towards and away from the skin and engage the skin without breaking the air tightness of the chamber; and characterized in that
   the plunger is operative to engage skin against vacuum forces during a first phase and disengage the skin during a second phase.

Clause 2. The apparatus according to clause 1, wherein the apparatus is also operative to
effect a treatment pressure pulse in tissue and to
extend a plunger through the chamber towards the skin without breaking the air tightness of the chamber and slowly urge the skin into the body of a user;
lock the plunger in the extended position against a loaded bias;
partially evacuate the vacuum chamber and create at least partial vacuum within the chamber bringing about urging of the skin against the plunger; and
allow the loaded bias to expand, rapidly drive the plunger away from the skin and allow the skin to be pulled into vacuum chamber.

Clause 3. The apparatus according to clause 1, wherein the apparatus is operative to effect a train of treatment pressure pulses by repeating an operating cycle several times.

Clause 4. The apparatus according to clause 1, wherein when the plunger slowly urges the skin into the body the plunger temporarily deforms the skin in a way comfortable to the user.

Clause 5. Apparatus comprising:
a housing (102) enclosing a vacuum chamber (104) including
   an open end (108) configured to engage a skin (150); and
   a sealed end (110) opposite the open end (108) communicating with a source of vacuum;
a plunger (106) operative to move axially inside the vacuum chamber (104) towards and away from skin (150) without compromising the air tightness of the chamber (104), the plunger (106) includes a shaft (118) operative to extend through and out of chamber (104); and characterized in that
a head (112) is attached to a first end of the shaft (118), the head spans most of chamber cross section without engaging chamber walls (116).

Clause 6. The apparatus according to clause 5, wherein the head (112) is convex in shape and operative to at least partially extend out of the chamber, urge and temporarily deform skin 150 into treated subject body in a way comfortable for the treated subject.

Clause 7. The apparatus according to clause 6, wherein the extension of the head out of the chamber effects a positive pressure phase inside tissue under the skin.

Clause 8. The apparatus according to clause 5, wherein the head (112) slowly displaces the skin and underlying tissue and slowly stretches the skin so that during the fast phase skin 150 is bent as the vacuum inside chamber 104 pulls and displaces skin 150 outwards from the body.

Clause 9. The apparatus according to clause 8, wherein the vacuum inside chamber 104 effects a negative pressure phase inside tissue under the skin.

Clause 10. The apparatus according to clause 1, wherein also comprising one or more valves located between the vacuum pump and the vacuum chamber.

Clause 11. The apparatus according to clause 10, wherein the valves also communicate with ambient air and/or a positive pressure pump and are operative to deliver ambient air into the vacuum chamber either from ambient air or from the positive pressure pump.

Clause 12. The apparatus according to clause 10, wherein the valves also communicate with ambient air and/or a positive pressure pump and during repeated operation the vacuum pump applies a continuous and constant level of vacuum in the vacuum chamber and the level of vacuum inside the chamber is regulated by at least one valve allowing a predetermined volume of ambient air to continuously or intermittently enter the chamber for a predetermine period of time.

Clause 13. The apparatus according to clause 10, wherein a level and/or pulse frequency of vacuum applied by the chamber is regulated of at least one valve communicating with at least one of vacuum pump, a positive pressure pump and ambient air and controlled by a controller.

Clause 14. The apparatus according to clause 1, wherein the plunger also comprises a head having holes to allow evacuation of trapped air between the head and a surface to which the apparatus is applied.

Clause 15. The apparatus according to clause 1, wherein the plunger also comprises a head having holes to allow evacuation of trapped air between the head and the membrane.

Clause 16. The apparatus according to clauses 1 or 20, wherein the force at which skin 150 is drawn against the plunger 106 when in the extended position or pulled into the vacuum chamber 104 once the plunger 106 is retracted and disengages the skin 150 depends solely on the pressure differential between tissue pressure and at least partial vacuum inside the chamber 104.

Clause 17. The apparatus according to clauses 1 or 5, wherein the force at which skin 150 is drawn against plunger 106 when in the extended position or pulled into the vacuum chamber 104 once the plunger 106 is retracted and disengages the skin 150 is not affected by the distance between the plunger 106 and the skin 150 or by the rate of acceleration at which the plunger 106 is retracted away from the skin 150.

Clause 18. The apparatus according to clauses 1 or 5, wherein an extended plunger 106 is operative to engage and hold the skin 150 in check against vacuum forces inside the chamber and acts as a barrier stopping the skin 150 and underlying tissue from being pulled into the vacuum chamber 104.

It will be appreciated by persons skilled in the art that the present method and apparatus are not limited to what has been particularly shown and described hereinabove. Rather, the scope of the method and apparatus includes both combinations and sub-combinations of various features described hereinabove as well as modifications and variations thereof which would occur to a person skilled in the art upon reading the foregoing description and which are not in the prior art.

What we claim is:

1. Apparatus comprising:
at least one chamber having an open end operative to be sealed by skin when applied thereto rendering the chamber air tight;
a vacuum pump communicating with the chamber and operative to generate at least partial vacuum inside the chamber; and
a plunger operative to move axially relative to the chamber towards and away from the skin and engage the skin without breaking the air tightness of the chamber; and characterized in that
the plunger is operative to engage skin against vacuum forces during a first phase and disengage the skin during a second phase.

2. The apparatus according to claim 1, wherein when engaging the skin, the plunger stops the skin from being pulled into the vacuum chamber.

3. The apparatus according to claim 1, wherein when the plunger disengages the skin the skin is free to be rapidly pulled into the vacuum chamber.

4. The apparatus according to claim 1, wherein the first phase and the second phase form an operating cycle in which the first phase is a slow phase and the second phase is a fast phase.

5. The apparatus according to claim 4, wherein the first phase is slower (longer) than 10 msec and the second phase is faster (shorter) than 10 mSec.

6. The apparatus according to claim 4, wherein the vacuum pump is operative to maintain at least partial vacuum within the vacuum chamber at least during the fast phase of the operating cycle.

7. The apparatus according to claim 1, wherein during the first phase the plunger is operative to push the skin into the body.

8. The apparatus according to claim 7, wherein the plunger is operative to push the skin at a speed slower than the speed at which it disengages the skin.

9. The apparatus according to claim 1, wherein the plunger includes a head that spans most of the open end without engaging rims of the open end or walls of the vacuum chamber.

10. The apparatus according to claim 3, wherein the plunger moves away from the skin at a speed greater than the speed at which the skin is pulled into the vacuum chamber.

11. The apparatus according to claim 1, wherein speed of movement of the plunger is phase-dependent.

12. The apparatus according to claim 1, wherein the plunger travel time during the first phase is more than 10 msec and during the second phase is less than 10 msec.

13. The apparatus according to claim 1, wherein the plunger moves towards the skin during the first phase and away from the skin during the second phase.

14. The apparatus according to claim 1, wherein also including a membrane attached to rims of the open end rendering the chamber airtight, disposed between the plunger and a surface to which the apparatus is applied.

15. The apparatus according to claim 4, wherein the first phase of the operating cycle generates a positive pressure pulse phase inside tissue.

16. The apparatus according to claim 4, wherein the second phase of the operating cycle generates a negative pressure pulse phase inside tissue.
